(19) United States
(12) Patent Application Publication
(10) Pub. No.: US 2018/0137575 A1
(43) Pub. Date: May 17, 2018

(54) METHODS FOR EMBEZZLEMENT RISK MODELING TO FACILITATE INSURANCE-BASED ASSET PROTECTION AND DEVICES THEREOF

(71) Applicant: Capital Shield LLC, Miromar Lakes, FL (US)

(72) Inventor: James M. Foglio, Miromar Lakes, FL (US)

(21) Appl. No.: 15/795,449

(22) Filed: Oct. 27, 2017

Related U.S. Application Data
(60) Provisional application No. 62/422,290, filed on Nov. 15, 2016.

(51) Int. Cl. G06Q 40/08

(52) U.S. Cl. CPC G06Q 40/08

(57) ABSTRACT

Methods, non-transitory computer readable media, and embezzlement risk analysis devices that obtain embezzlement risk data for at least one trusted entity in response to an insurance underwriting request received via one or more communication networks from a client computing device. The embezzlement risk data obtained from one or more embezzlement risk data source devices via another one or more communication networks. At least one risk level associated with the trusted entity is generated based on the obtained embezzlement risk data. The risk level is reflective of a risk of loss of assets made available to the trusted entity due to a misappropriation of the assets by the trusted entity. An insurance underwriting decision is then generated based on the risk level and the insurance underwriting decision is output to the client computing device via the one or more communication networks.

This application claims the benefit of U.S. Provisional Patent Application Ser. No. 62/422,290, filed on Nov. 15, 2016, which is hereby incorporated by reference in its entirety.

### FIELD

This technology generally relates to improved, automated embezzlement risk modeling to facilitate insurance-based asset protection.

### BACKGROUND

Many types of insurance products exist that facilitate the protection of assets with respect to the occurrence of adverse events. Some types of insurance products protect physical assets, such as home and automobiles. Other types of insurance products protect against identity theft or employee theft, for example. However, insurance is not currently available to protect personal financial assets or investments from being stolen or embezzled by a joint business owner, advisor, partner, or other trusted entity.

Such insurance is not available at least because there is no effective way to model risk for an investor of personal financial assets that can inform the insurance underwriting process. Accordingly, investors often make financial assets available to a trusted entity without any awareness of potential risks and/or any protection against loss of those assets as a result of embezzlement, for example, by the trusted entity.

### BRIEF DESCRIPTION OF THE DRAWINGS

FIG. 1 is a block diagram of an exemplary network environment with an embezzlement risk analysis device; and

FIG. 2 is a flowchart of an exemplary method for embezzlement risk modeling to facilitate insurance-based asset protection.

### DETAILED DESCRIPTION

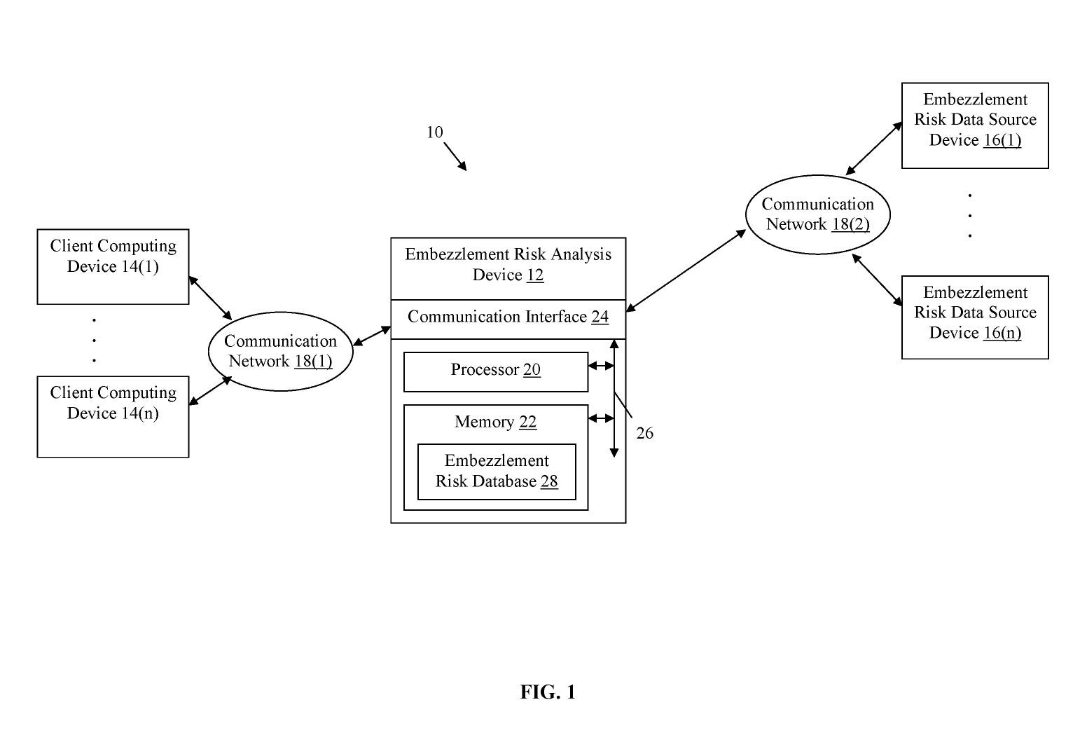

An exemplary network environment 10 with an embezzlement risk analysis device 12 coupled to client computing devices 14(1)-14(n) and an embezzlement risk data source devices 16(1)-16(n) by communication networks 18(1), and 18(2) is illustrated in FIG. 1, although this network environment 10 can include other numbers and types of systems, devices, and elements in other configurations. While not shown, the network environment 10 also may include additional network components such as routers and switches which are well known to those of ordinary skill in the art and thus will not be described here. This technology provides a number of advantages including methods, non-transitory computer readable media, and devices that more effectively model risk associated with making financial assets available to a joint business owner, advisor, partner, or other trusted entity in order to inform insurance underwriting decisions and facilitate asset protection via insurance policies.

The embezzlement risk analysis device 12 in this example includes a processor 20, a memory 22, and a communication interface 24, which are coupled together by a bus 26 or other communication link, although other numbers and types of systems, devices, components, and elements in other configurations and locations can also be used. The processor 20 in the embezzlement risk analysis device 12 executes a program of stored instructions for one or more aspects of the present technology, as described and illustrated by way of the examples herein, although other types and numbers of processing devices and configurable hardware logic could be used and the processor 20 could execute other numbers and types of programmed instructions.

The memory 22 in the embezzlement risk analysis device 12 stores these programmed instructions for one or more aspects of the present technology as described and illustrated herein, although some or all of the programmed instructions could be stored and executed elsewhere. A variety of different types of memory storage devices, such as a RAM, ROM, floppy disk, hard disk, CD-ROM, DVD-ROM, or other computer readable medium which is read from and written to by a magnetic, optical, or other reading and writing system that is coupled to the processor 20, can be used for the memory 22.

In this example, the memory 22 includes an embezzlement risk database 28. The embezzlement risk database 28 is a repository for embezzlement risk data including background check data, and other information reflective of the trustworthiness of the person or entities identified therein, which is obtained from the embezzlement risk data source devices 16(1)-16(n). Optionally, the embezzlement risk database 28 can also store one or more risk levels associated with each of the persons or entities identified therein, which can be generated based on the embezzlement risk data and used to inform underwriting decisions, as described and illustrated in more detail later. In other examples, the memory 22 can store other information in other formats, and the information stored in the embezzlement risk database 28 can also be stored elsewhere.

The communication interface 24 in the embezzlement risk analysis device 12 is used to operatively couple and communicate between the embezzlement risk analysis device 12, the client computing devices 14(1)-14(n) and the embezzlement risk data source devices 16(1)-16(n) via the communication networks 18(1) and 18(2), although other types and numbers of connections and configurations can also be used. By way of example only, the communication networks 18(1) and 18(2) can include one or more local area networks or wide area networks, for example, and can use TCP/IP over Ethernet and industry-standard protocols, including hypertext transfer protocol (HTTP) and secure HTTP (HTTPS), although other types and numbers of communication networks, such as a direct connection, modems and phone lines, e-mail, and wireless and hardwire communication technology, each having their own communications protocols, can also be used.

The client computing devices 14(1)-14(n) in this example each include a processor, a memory, a communication interface, an input device, and a display device, which are coupled together by a bus or other communication link. The client computing devices 14(1)-14(n) can also have other numbers and types of systems, devices, components, and elements in other configurations and locations. The client computing devices 14(1)-14(n) can be mobile computing devices, smartphones, tablets, laptops, desktop computers, or any combination thereof. Investors can use the client computing devices 14(1)-14(n) to interface with the embezzlement risk analysis device 12 to request insurance coverage and other information regarding a joint business owner, advisor, partner, or other trusted entity, for example, as described and illustrated in more detail later.

The embezzlement risk data source devices 16(1)-16(n) in this example each include a processor, a memory, and a communication interface, which are coupled together by a bus or other communication link. The embezzlement risk data source devices 16(1)-16(n) can also have other numbers and types of systems, devices, components, and elements in other configurations and locations. In some examples, the embezzlement risk data source devices 16(1)-16(n) include one or more server computing devices hosted by providers of embezzlement risk data.

Although examples of the embezzlement risk analysis device 12, client computing devices 14(1)-14(n) and the embezzlement risk data source devices 16(1)-16(n), which are coupled together via the communication networks 18(1) and 18(2) are described herein, other types and/or numbers of computer systems or computing devices can also be used. It is to be understood that the devices and systems of the examples described herein are for exemplary purposes, as many variations of the specific hardware and software used to implement the examples are possible, as will be appreciated by those skilled in the relevant art(s).

In addition, two or more computing systems or devices can be substituted for any one of the systems in any embodiment of the examples. The examples may also be implemented on computer device(s) that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, or combinations thereof.

The examples may also be embodied as a non-transitory computer readable medium having programmed instructions stored thereon for one or more aspects of the present technology as described and illustrated by way of the examples herein. The programmed instructions, when executed by a processor, cause the processor to carry out the steps necessary to implement one or more methods of the examples, as described and illustrated herein.

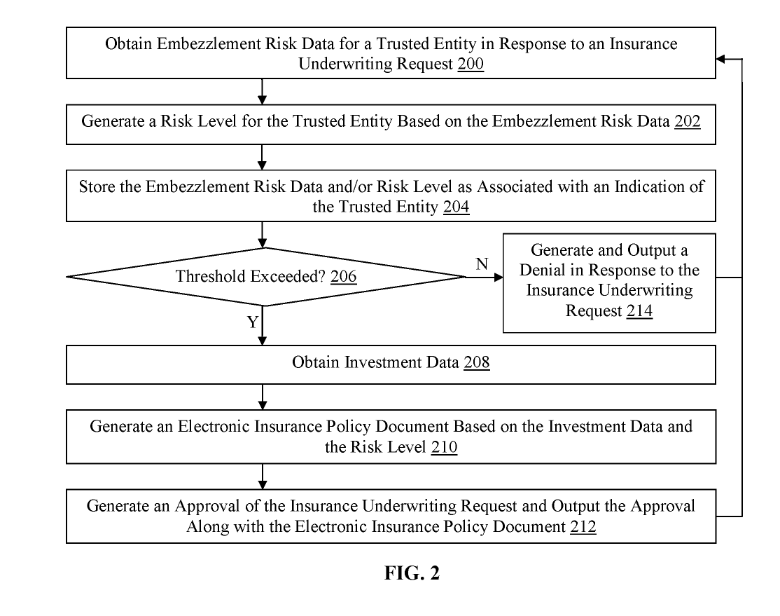

An exemplary method for embezzlement risk modeling to facilitate insurance-based asset protection will now be described with reference to FIGS. 1-2. In step 200 in this particular example, the embezzlement risk analysis device 12 obtains embezzlement risk data for at least one joint business owner, advisor, partner, or any other person or entity to which financial assets may be made available (referred to herein as a trusted entity) in response to an insurance underwriting request. The insurance underwriting request can include an indication of, and/or information regarding, the trusted entity be used by the embezzlement risk analysis device to obtain the embezzlement risk data. In this example, the insurance underwriting request can be received from one of the client computing devices 14(1)-14(n) associated with an investor or other person interested in making financial assets available to the trusted entity.

The embezzlement risk data can be obtained from one or more of the embezzlement risk data source devices 16(1)-16(n) and can include background check information, information regarding historical investment performance, adverse events related to historical investments associated with the trusted entity, and/or litigation history of the trusted entity, for example, although other types and numbers of embezzlement risk data can also be obtained in step 200.

In step 202, the embezzlement risk analysis device 12 generates at least one risk level associated with the trusted entity based on the obtained embezzlement risk data. The risk level can be a score or any other value or indicator that is reflective of a risk of loss of assets invested with the trusted entity due to a misappropriation (e.g., stealing or embezzling) of the assets by the trusted entity. Optionally, various weights can be applied to one or more portions of the embezzlement risk data in order to generate the risk level, and other types and numbers of risk levels and/or methods of generating the risk level can be used in other examples.

In step 204, the embezzlement risk analysis device 12 optionally stores the embezzlement risk data and the generated risk level, such as in the embezzlement risk database 28. The embezzlement risk data and/or risk level can be stored as associated with the trusted entity and optionally retrieved in step 200 and used in step 202 to generate a risk level for the trusted entity in a subsequent iteration and in response to another request for an underwriting decision from one of the client computing devices 14(1)-14(n).

In step 206, the embezzlement risk analysis device 12 determines whether a preestablished threshold risk level has been exceeded by the risk level generated in step 202. The threshold risk level can be stored in the memory 22 and can be used to determine whether to generate a positive or negative insurance underwriting decision for the investor, although other methods of determining whether to underwrite an insurance policy for the investor can also be used in other examples. Accordingly, if the embezzlement risk analysis device 12 determines in step 206 that the generated risk level exceeds the threshold risk level, then the Yes branch is taken to step 208.

In step 208, the embezzlement risk analysis device 12 optionally obtains investment data including, for example, information regarding the assets that the investor will make available to the trusted entity such as the size and composition of the assets, for example, although other types of characteristics regarding the assets can also be included in the investment data. The investment data can be obtained from the one of the client computing devices 14(1)-14(n) from which the insurance underwriting request was received in step 200, such as via one or more graphical user interfaces (GUIs) provided by the embezzlement risk analysis device 12 via the communication network 18(1), for example.

In step 210, the embezzlement risk analysis device 12 optionally generates an electronic insurance policy document based on the investment data obtained in step 208 and the risk level generated in step 202. Various aspects of the electronic insurance policy document, such as the associated premium, can be automatically populated by the embezzlement risk analysis device 12. Optionally, the electronic insurance policy document can include any number of disclaimers, exclusions, and/or limitations, such as that proceeds will not be paid to the investor for negative performance of the investment or any type of bankruptcy filing on behalf of an entity associated with the investment.

In step 212, the embezzlement risk analysis device 12 generates and outputs an approval of the insurance underwriting request to the one of the client computing devices 14(1)-14(n) via the communication network 18(1). In examples in which the electronic insurance policy document is generated in step 210, the electronic insurance policy document can be output to the one of the client computing devices 14(1)-14(n) along with the approval in step 212.

Referring back to step 206, if the embezzlement risk analysis device 12 determines that the risk level generated in step 202 does not exceed the preestablished threshold risk level, then the No branch is taken to step 214. In step 214, the embezzlement risk analysis device 12 generates and outputs a denial of the insurance underwriting request to the one of the client computing devices 14(1)-14(n) via the communication network(s) 18(1).

Accordingly, with this technology, an embezzlement risk analysis device more effectively facilitates modeling investor risk with respect to investing assets with a trusted entity in order to inform an insurance underwriting decision. This technology automatically performs due diligence with respect to an identified trusted entity by obtaining embezzlement risk data from a number of data sources to generate an indication of the risk of investing with the trusted entity. The risk level can be used by insurance underwriters to make informed underwriting decisions for prospective investors in order to facilitate a level of insurance-based asset protection. Accordingly, this technology provides a technical solution to the technology problem of effectively modeling embezzlement risk data in order to more effectively inform insurance underwriting decisions.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for embezzlement risk modeling to facilitate insurance-based asset protection implemented by one or more embezzlement risk analysis devices, the method comprising:
obtaining embezzlement risk data for at least one trusted entity in response to an insurance underwriting request received via one or more communication networks from a client computing device, the embezzlement risk data obtained from one or more embezzlement risk data source devices via another one or more communication networks;
generating at least one risk level associated with the trusted entity based on the obtained embezzlement risk data, wherein the risk level is reflective of a risk of loss of assets made available to the trusted entity due to a misappropriation of the assets by the trusted entity; and
generating an insurance underwriting decision based on the risk level and outputting the insurance underwriting decision to the client computing device via the one or more communication networks.

2. The method of claim 1, further comprising determining when the risk level exceeds a preestablished threshold risk level, wherein:
the insurance underwriting decision comprises an approval of the insurance underwriting request, when the determining indicates that the risk level exceeds the preestablished threshold risk level; and
the insurance underwriting decision comprises a denial of the insurance underwriting request, when the determining indicates that the risk level does not exceed the preestablished threshold risk level.

3. The method of claim 2, further comprising, when the determining indicates that the risk level exceeds the preestablished threshold risk level:
obtaining investment data corresponding to the assets; and
generating and outputting an electronic insurance policy document based on the investment data and the risk level.

4. An embezzlement risk analysis device, comprising memory comprising programmed instructions stored thereon and one or more processors configured to be capable of executing the stored programmed instructions to:
obtain embezzlement risk data for at least one trusted entity in response to an insurance underwriting request received via one or more communication networks from a client computing device, the embezzlement risk data obtained from one or more embezzlement risk data source devices via another one or more communication networks;
generate at least one risk level associated with the trusted entity based on the obtained embezzlement risk data, wherein the risk level is reflective of a risk of loss of assets made available to the trusted entity due to a misappropriation of the assets by the trusted entity; and
generate an insurance underwriting decision based on the risk level and output the insurance underwriting decision to the client computing device via the one or more communication networks.

5. The embezzlement risk analysis device of claim 4, wherein the one or more processors are further configured to be capable of executing the stored programmed instructions to determine when the risk level exceeds a preestablished threshold risk level, wherein:
the insurance underwriting decision comprises an approval of the insurance underwriting request, when the determining indicates that the risk level exceeds the preestablished threshold risk level; and
the insurance underwriting decision comprises a denial of the insurance underwriting request, when the determining indicates that the risk level does not exceed the preestablished threshold risk level.

6. The embezzlement risk analysis device of claim 5, wherein the one or more processors are further configured to be capable of executing the stored programmed instructions to, when the determining indicates that the risk level exceeds the preestablished threshold risk level:
obtain investment data corresponding to the assets; and
generate and output an electronic insurance policy document based on the investment data and the risk level.

7. A non-transitory computer readable medium having stored thereon instructions for embezzlement risk modeling to facilitate insurance-based asset protection comprising executable code which when executed by one or more processors, causes the one or more processors to:
obtain embezzlement risk data for at least one trusted entity in response to an insurance underwriting request received via one or more communication networks from a client computing device, the embezzlement risk data obtained from one or more embezzlement risk data source devices via another one or more communication networks;
generate at least one risk level associated with the trusted entity based on the obtained embezzlement risk data, wherein the risk level is reflective of a risk of loss of assets made available to the trusted entity due to a misappropriation of the assets by the trusted entity; and
generate an insurance underwriting decision based on the risk level and output the insurance underwriting decision to the client computing device via the one or more communication networks.

8. The non-transitory computer readable medium of claim 7, wherein the executable code when executed by the one or more processors further causes the one or more processors to determine when the risk level exceeds a preestablished threshold risk level, wherein:
the insurance underwriting decision comprises an approval of the insurance underwriting request, when the determining indicates that the risk level exceeds the preestablished threshold risk level; and
the insurance underwriting decision comprises a denial of the insurance underwriting request, when the determining indicates that the risk level does not exceed the preestablished threshold risk level.

9. The non-transitory computer readable medium of claim 8, wherein the executable code when executed by the one or more processors further causes the one or more processors to, when the determining indicates that the risk level exceeds the preestablished threshold risk level:
obtain investment data corresponding to the assets; and
generate and output an electronic insurance policy document based on the investment data and the risk level.
